(19) United States
(12) Patent Application Publication
(10) Pub. No.: US 2004/0163313 A1
(43) Pub. Date: Aug. 26, 2004

(54) Hydrogen generation apparatus

(76) Inventor: Robert E. Buxbaum, Oak Park, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/784,055

(22) Filed: Feb. 20, 2004

Related U.S. Application Data
(60) Provisional application No. 60/448,001, filed on Feb. 20, 2003.

(51) Int. Cl. C01B 3/26; B01J 8/00

(52) U.S. Cl. 48/214 R; 48/75; 48/102 R; 48/105; 48/107; 48/93; 48/94; 48/95; 48/127.9; 48/198.1; 48/198.3; 48/198.7; 48/211; 48/212; 48/215; 48/214 A

(57) ABSTRACT

A hydrogen generation apparatus includes controls for delivering a feedstock to a reactor and a water gas step membrane reactor operating at a lower temperature than the reactor so as to efficiently produce purified hydrogen and manage heat within the apparatus. Catalytic combustion of feedstock in the presence of a combustible gas based on a computer controller facilitates operation. Flat plate heat exchangers in various configurations are contemplated as a reactor, water gas step membrane reactor, and purifier. Catalytic burning of feedstock in the presence of a combustible gas enhances apparatus efficiency.

### RELATED APPLICATIONS

This application claims priority of U.S. Provisional Patent Application No. 60/448,001 filed Feb. 20, 2003.

### FIELD OF THE INVENTION

The present invention in general relates to hydrogen reforming and, in particular, to the use of a water shift step to complete the reformation process.

### BACKGROUND OF THE INVENTION

The viability of fuel cell technologies rests with the use of a fuel cell conferring an efficiency advantage over conventional combustion-based energy systems. Appreciable fuel cell efficiency is lost through the considerable energy consumption required to convert a feedstock such as ammonia, methane, methanol or higher aliphatics into hydrogen gas.

Heat management remains an issue in hydrogen production. In conventional large-scale systems, process stages are separated by external piping and several heat exchanger stages between the reactor and separator components. This approach has been embraced at an industrial production for hydrogen production systems generally producing greater than 50,000 liters per day. This approach is attractive at large scales owing to the ability to manufacture and assemble large conventional vessels and fittings at a low cost. At smaller scale production, equipment cost and cost of preheating feedstock and maintaining the various stages at operating temperature greatly reduces the efficiency of large-scale steam reformers. Such reformers typically operate above ambient pressure and at temperatures that can approach 900° C. Alternatively, small-scale hydrogen production systems often incorporate multiple stages into an integrated unit. But such integrated systems have their problems. Jacketing a primary steam reformer or cracker with a secondary stage water gas reactor in which CO+H₂O→H₂O+CO₂ can reduce efficiency since elevated temperature inhibits this endothermic reaction. Thus, there exists a need for a hydrogen generation apparatus that efficiently manages heat and hydrogen production, particularly at small scale.

### SUMMARY OF THE INVENTION

A flat plate hydrogen purifier according to the present invention is operative in various embodiments as a steam reformer, ammonia cracker, water gas step membrane reactor or purifier. The heat exchangers characterized by non-concurrent flow of two gas streams pulling in channels separated by an intermediate membrane. Multiple stacks of flat plates in such heat exchangers are provided to increase throughput.

A hydrogen generation apparatus includes a boiler that receives water or a liquid fuel feedstock from a pump. A reactor produces hydrogen from the heated feedstock received from the boiler. A burner in thermal communication with the reactor catalytically or conventionally combusts a mixture of feedstock and combustible gas. Heat output from the burner is controlled through a first control valve operating under the command of a computer controller. A reactor pressure sensor communicates hydrogen output reactor pressure to the computer controller. A secondary stage in fluid communication with the reactor includes a membrane separation that delivers a purified product gas to a product outlet and a rafinate gas stream. The combustion products from the burner are moved by way of a waste gas outlet in fluid communication with the burner. Heat exchange between the waste gas stream and feedstock in the boiler increases energy recovery in the apparatus.

A process for forming hydrogen from a feedstock includes providing a heated feedstock to a reactor and allowing sufficient resonance time for the feedstock and the reactor to undergo an endothermic reaction to yield hydrogen and endothermic reaction product. The mixture of hydrogen and endothermic reaction product are transferred to a secondary stage water gas step membrane operating at a lower temperature than the reactor to yield a purified hydrogen flow and a rafinate gas flow.

### BRIEF DESCRIPTION OF THE DRAWINGS

FIG. 1 is a partly exploded view of an inventive hydrogen extractor operative as a membrane reactor, reformer or purifier; and

FIG. 2 is a schematic of flows for an inventive hydrogen generation apparatus.

### DESCRIPTION OF THE INVENTION

A previous patent by Robert Buxbaum strongly implies, but does not directly state that it is advantageous to make hydrogen using a membrane or membrane reactor that is fed synthesis gas produced by a separate, reformer reactor that would operate at higher temperature. The advantage is that the membrane reactor can then operate at a temperature range ideal for flat plat construction or for performing the water gas shift reaction. In either case this optimal temperature is lower than that which is advantageous for high temperature reforming reactions. To give the example of making hydrogen from natural gas, the preferred reforming reaction temperature is about 850C, but the preferred temperature for the water gas shift reaction on current catalysts is lower, about 350 C. One could reform the natural gas all the way to hydrogen in a membrane reactor via the combined reaction

CH4+2H2O—>4H2+CO2,

because continuous hydrogen removal can be used to drive the reaction to completion, even at non-ideal temperatures, but this makes severe demands on the pressure and materials use. The other normal technique would be to make hydrogen in a series of reactors (reformer, high temperature water-gs shift, low temperature water gas shift) followed by a separation unit. The technique we preent here is a hybrid between these two; that one reform the natural gas to synthesis gas in a reformer reactor at high temperature via the reaction:

CH4+H2O—>3H2+CO

and then perform the water gas reaction in a single step at lower temperature in a membrane reactor.

CO+H2O—>H2+CO2

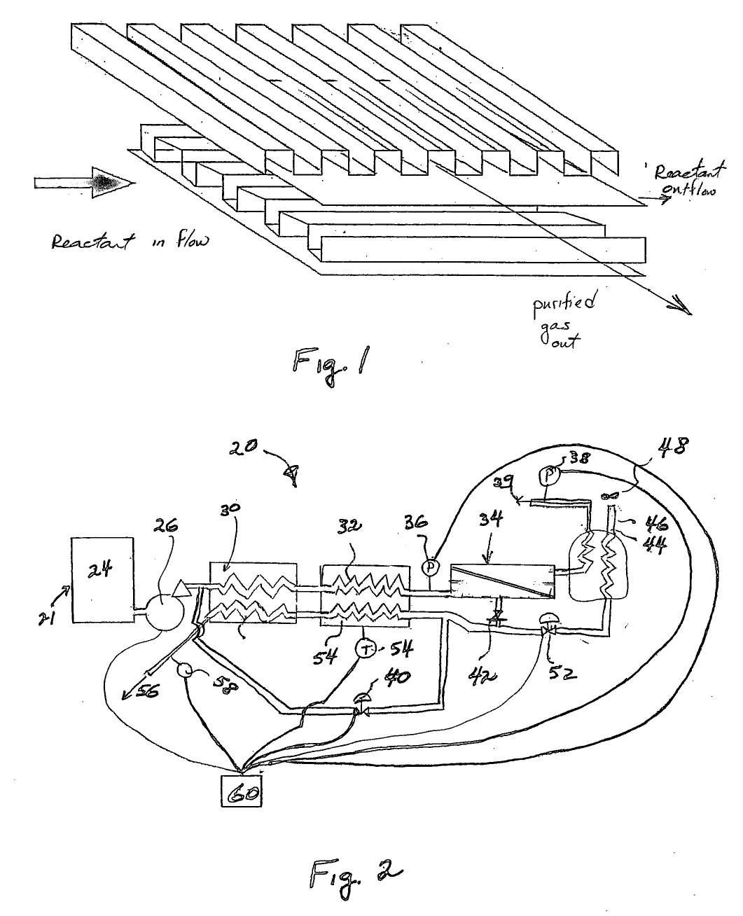

A flow arrangement for doing this is shown in FIG. 2, while an innovative, flat plate purifier/membrane reactor design is shown in FIG. 1. When the natural gas reforming reaction is done with this setup, we get most of the advantages of a sequential reactior, hydrogen-generator, and most of the advantages of a membrane reactor hydrogen generator. The reforming reaction can be done at high temperature, and the water-gas reaction can be done at lower temperture as in a sequential set-up, while we achieve the simplicity and efficiency advantage of replacing the two water-gas shift reactors and hydrogen purifier by a single membrane reactor. It is not an oversight that FIG. 2 shows no heat exhanger between the reformer stage and the reformer stage. The heat exchanger is not an integral part of the invention as, in many cases it will be possible to rely on the shedding heat losses from the membrane reactor (or purifier) to maintain that stage at a lower temperature than the reformer.

Not only does this set-up promote heat exchange for the various reactions, but it also relieves serious materials constraints on the membranes. With a single stage membrane reactor/hydrogen generator, the membranes had to be fairly high temperature stable. Here, the lower temperature of operation allows the membranes to be made of lower cost, lower temperture materials. It is even possible, with this design to consider a case where the separation membranes are polymeric. Polymeric membranes are not a practical option for a one-stage membrane reactor/hydrogen generator. Using polymeric membranes can save membrane cost, and opens up the possibility of extracting both hydrogen and CO2 and not just hydrogen.

A previous patent from REB held that for a one step membrane reactor that made hydrogen from hydrocarbons, ammonia or methanol, some of the heat to the membrane reactor should come from burning the waste gas rafinate from the membrane reactor. Extending that patent idea to the current invention, once the reformer and the WGS reactor is separated, heat to the reformer should come from burning the waste gas rafinate.

For applications like the above, it is desired to have high pressure gases exposed to the maximum exchange surface in a small volume. A very efficient way to do this is to make the membrane reactor, or reformer, or purifier in the same general layout as used in brazed fin, flat plate heat exchangers. The simplest version, a hydrogen purifier of this design is shown below:

This drawing shows a two layer extractor, though for large scale production a repeating structure of this type would be used. As shown, a flow of hydrogen containing reactants, e.g. from a reformer, flows through the lower series of channels; purified hydrogen flows upward through the membrane, and out of the purifer from the upper series of channels (towards the viewer). Rafinate gas (left-overs) flows out to the right. Separating the upper and lower channels is a thin layer of hydrogen permeable material, e.g. palladium 40% copper foil. The rear surface of the purifier (not shown) is closed off, or can be open to allow the flow of a sweep gas, and the whole is surrounded by a flow manifold to keep the various flows separate. This type of flat plate purifier can be made light weight at lower cost than would be possible with shell and tube purifiers, or traditionally backed flat plate designs. A tradioional flat plat design of hydrogen extractor is produced currently in the US by Wah Chang, and High 9; such purifiers are produced in Japan by Tokyo Gas. The membrane reactor version of the above is identical except that the reactant channels are filled with catalyst or are dip-coated with catalyst.

FIG. 2 shows several other novel aspects, that are not needed for all applications, but are advantageous for some. One novel aspect is the use of a catalytic burner to heat the reformer. The normal way to heat the reformer is with a flame; a catalytic burner can make this combustion more efficient, and can save weight, space and cost. Another novel aspect is the use of a boiler/heat exchanger that boils and pre-heats the feed using heat left-over in the reformer heating stream. This is an energy saving aspect. Similarly we pre-heat the air to the combustor using heat left over in the hydrogen. This saves energy and also provides hydrogen at a temperature that is more generally useful than that typically found in a membrane reactor or membrane extractor. Further, we show the catalytic combustor fed with both waste gas (raffinate) from the purifier, membrane reactor, and with raw feed. This is done for start-up and efficient operation benefits. During steady state operation at maximum output, we expect that the majority of heat to the reformer or cracker reactor will come from combustion of raffinate. During startup and high turndown operation, much of the heat will come from combustion of raw feed.

Other feedstocks that could be used with the set-up in FIG. 2, and with the flat plate extractor/membrane reactor in FIG. 1 include ammonia (ammonia can be “cracked” to make hydrogen) or a mixture of methanol and water flows. For ammonia cracking, there is no need for a low temperature water-gas reaction, but the design reatins the materials and cost advantage of being able to perform the ammonia cracking reaction at a high temperture while extraction hydrogen at a lower temperature.

Control of the Reactor or Reactors:

Control is always a tricky matter; gnerally the problem is deciding where to take input data and deciding what to control with that data. FIG. 2 shows several sensors and valves, as well as an integrated controller. We plan to measure and control pressure, both at the reactor and at the hydrogen output. The use of a pressure sensor at the reactor and a integrated circuit pump controller is that, for quick startup it is helpful if the pump speed is higher than it is at steady state, while for long term operation, it is generally worthwhile to maintain a constant reactor pressure. Our current method of maintaining reactor pressure is to use a check valve on the raffinate from the reactor. This a low-cost solution that is effective at keeping the reactor pressure constant, but during start-up one currently has to adjust the pump rate by hand. In FIG. 2 we retain the check valve, but include an integrated controller sending signals to the pump. This system provides for faster, less hands-on startup and can also provide a safety backup in case the check valve fails shut. For some applications, it may be worthshile to add a variable control in parallel with the check valve, but we show a pressure relief check valve, because this will be used for all systems at least as a back-up. Currently such valves cost only $20.

FIG. 2 also shows a pressure sensor at the hydrogen output. This is particularly advantageous for fuel cell and similar applications where hydrogen overpressure can be damaging. The control idea is to control the feed pump rate to maintain a constant hydrogen output pressure so that the pump rate is increased if the hydrogen output pressure gets too low. Similarly, the controler would turn-down or shut off the pump if the hydrogen pressure to the fuel cell gets too large. The maximum pressure is about 15 psig for current fuel cells.

A preferred design of a maximum exchange surface in a small volume is to make the membrane reactor, reforming or cracking reactor, or purifier in the form of a brazed fin flat plate heat exchanger. A hydrogen purifier of this design is shown in FIG. 1. FIG. 1 shows two channels of an inventive structure. It is appreciated that in the purifier shown in FIG. 1, a flow of hydrogen and endothermic reaction product, a plurality of stacked channels are provided based on the scale of an inventive system, such as the gas mixture derived from a reformer, flows through the lower series of channels from the left as depicted, purified hydrogen flows out from the upper series of channels as depicted and rafinate gas flows out to the right as depicted. Separating the upper and lower channels is a thin layer of hydrogen permeable material, illustratively including palladium 40% copper foil. It is appreciated that a variety of hydrogen permeable materials are operative herein and include those detailed in U.S. Pat. No. 5,935,987. The rear surface of the purifier is optionally sealed or is open to allow the flow of a sweep gas. The purifier is coupled to a flow manifold to keep the various gas streams separate. The use of this sort of flat plate design allows for a high pressure-stable design that is lighter weight and lower cost than would be possible otherwise. A flat plate heat exchanger is readily formed from metals, ceramic or polymers by conventional technique. If the case of metals or ceramics, these techniques illustratively include slip or tape casting followed by consuming any binders present, where a metal is ductile stamping is also an operative forming technique. Polymeric heat exchangers are readily formed by injection molding or casting a prepolymer in a desired shape.

A membrane reactor embodiment of an inventive purifier includes reactant channels filled with catalyst-containing media or are themselves coated with catalyst.

The catalyst being selected to facilitate a desired reaction at intended reactor operating temperatures in the reformer embodiment of an inventive purifier a raw fuel, illustratively including ammonia, or a mixture of methanol and water flows in where the reactants are shown to flow and exits with the reactants having been partially converted to hydrogen, absent hydrogen extraction. Instead, in a reformer embodiment an inventive purifier has upper channels containing heated gases. More preferably, combustion is facilitated by a catalyst located in the upper chamber 6. The thin layer between the two channels in this embodiment is not hydrogen permeable but rather is a thermally conductive layer.

Reactor control involves the problem of deciding where to collect input data and deciding what to control with that data. Pressure data is a particularly useful preferred data source. More preferably, pressure data is collected both at the reactor and at the hydrogen output.

Referring now to FIG. 2, an inventive hydrogen generation apparatus is shown generally at 20. A feedstock supply vessel 22 contains a feedstock 24 for reaction to yield hydrogen. It is appreciated that the nature of supply vessel 22 material choice is dictated by factors including in part the corrosivity and material state of the feedstock as gas or liquid. Optionally, a fill port 25 is provided to allow resupply to the vessel 22 without disrupting operation. A variety of steel allows are known to the art that are tolerant of the feedstock and reaction products at the temperatures associated with reaction and purification. Typical feedstocks operative herein illustratively include the aqueous mixtures of -alcohols, -ketones, -alkanes, -alkynes, -aldehydes, aliphatics and ammonia. Specific examples of organic feedstocks include methanol, methane, ethylene and octane.

The feedstock 24 is metered from the supply vessel 22 by a pump 26 and into a boiler 30. The boiler preheats the feedstock 24 to the reactor temperature for efficient operation of an endothermic reaction reactor 32 in fluid communication therewith. It is appreciated that the optimal temperature of reactor 32 operation is dictated in part by nature of the catalyst, feedstock, throughput thereof. Typical operating temperatures for a reactor are between 400 and 900° C. with feedstock inlet pressures of 10 to 30 atmospheres being common. The boiler 30 typically heats the feedstock 24 to temperatures within 30 percent of the operating temperature of the reactor 32, where temperature percent is calculated in degrees Kelvin. Preferably, the feedstock 24 is heated in the boiler 30 to within 15 percent of the boiler operating temperature. While the boiler 30 is depicted schematically in FIG. 2 a unit isolated from the reactor 32, it is appreciated that superior hear management is obtained through jacketing the reactor 32 with the boiler 30, as shown in U.S. Pat. No. 6,168,650 B1.

The reactor 32 is preferably in the form of a flat plate heat exchanger as depicted in FIG. 1 where heated gases are passed orthogonal to feedstock flow through the reactor. It is appreciated that multiple stacks of heat exchangers are operative to increase throughout or alternatively resort to conventional tube reactors is also operative herein. When the feedstock is a steam-organic feedstock mixture, the reactor 32 is preferably equipped with a conventional reformer catalyst and operated under conditions that produce CO preferentially relative to CO2. When the feedstock is ammonia, a conventional cracker catalyst is preferably added to the reactor 32 and operation is under conditions that facilitate the reaction 2 NH₃—N₂+3H₂.

The reactor product stream yields hydrogen and an endothermic reaction product that a passed to a lower operating temperature secondary stage 34.

The reaction products from the reactor 32 preferably monitored by a pressure sensor 36 intermediate between the reactor 32 and the secondary stage 34.

The secondary stage 34 is configured only as a hydrogen purifier in the instance where the reactor 32 is an ammonia cracker at an instance where the reactor 32 operates as a reformer, the secondary stage 34 is a water gas step membrane reactor. Preferably, the secondary stage 34 is of a flat-plate heat exchange designed as detailed with respect to FIG. 1 in containing particular constituents therein consistent with the intended purpose therefor as detailed herein above. Purified hydrogen passing onto the purified side of the secondary stage 34 is collected as a purified product. Preferably, a second pressure sensor 38 monitoring purified hydrogen output is preferred. An advantage of the present invention in that having pressure sensors 36 sensitive to reactor pressure and a second pressure sensor 38 sensitive to purified hydrogen output is that an integrated circuit pump controller 40 upon apparatus startup is operable at higher than steady state speed in order to quickly build reactor pressure.

A check valve 42 of the rafinate from the second stage 34 is preferably provided to maintain the reactor 32 a constant pressure. It is appreciated that reactor pressure is also readily maintained through additional sensory inputs of temperature and/or pressure upstream of the reactor 32 in the event that a check valve 42 or its equivalent is absent.

The pressure sensor 38 affords the ability to shut off, to modify the speed of pump 26 in response to the downstream requirements of, for instance, a fuel cell. The pressure sensor 32 also serves as an additional safety control.

Preferably, a heat exchanger 44 withdraws heat from the purified hydrogen stream 39. The heat withdrawn from the purified hydrogen stream 39 is imparted to a combustion supporting gas 45 entering the apparatus 20 by way of inlet 46. The combustion supporting gas 45 illustratively includes air and oxygen. Preferably, the combustion gas 45 is ambient air. Preferably, a fan 48 is provided to actively draw air into the inlet 46. Transferring heat between the purified hydrogen 39 and the combustion gas 45 within the heat exchanger 44 serves to promote maintenance of operating temperature within the reactor 32. The combustion gas 45 is metered to a catalytic burner 50 within the reactor 32 by way of a control valve 52. A computer (not shown) collects input data from pressure sensors 36 and 38 as well as a thermometer 54 monitoring the temperature within the reactor 32. The computer is capable of storing sensor output and modulating the activity of control valves 40 and 52 in order to maintain the apparatus 20 in a status input by a user. Various apparatus control operations include startup, continual operation, input parameter modified continual operation, and shut down. In addition to computer control of various apparatus operational modes, it is appreciated that an inventive apparatus also operated under manual control or various components are selectively placed under manual control. For instance, controlled pump 26 is optionally under manual control during startup. Control valves 40 and 52 are adjusted to control the flow of feedstock to the boiler 30 using the temperature of the reactor 32 is one measured variable for control thereof. A computer controller according to the present invention turns off the flow of feedstock to the catalytic burner 50 if the reactor 32 has a temperature in excess of a preselected threshold. Preferably, should the temperature within the reactor 32 rapidly exceed a preselected threshold, one has the ability to shut off the flow of feedstock entering the reactor 32 by way of the boiler 30 and feedstock metered to the catalytic burner 50 by way of control valve 40 while simultaneously increasing the flow of combustion gas 45 by way of control valve 52. With this set of valving operations, the reactor temperature is rapidly decreased to below a preselected threshold. While the reactor 32 is within the normative control range of temperature, optionally, purified hydrogen output 39 is measured by pressure sensor 38 is the sole control over feedstock metering to the reactor 32 by way of the boiler 30. Under steady state operation of the present invention, control of combustion gas 45 entering inlet 46 is maintained with control valve 52 to burn stoichiometrically so as to maintain a preselected oxygen content in the waste gas 56 exiting the apparatus 20. Optionally, an oxygen sensor 58 monitors the waste gas stream 56 for oxygen content information is communication to the computer controller so as to adjust the combustion mixture composition within the catalytic burner 50. By way of example, inventive apparatus operating at 85% efficiency uses 10.7+/−0.9 cubic centimeters of air per minute to yield one kilowatt producing amount of purified hydrogen.

During normal operation of an inventive apparatus 20, the check valve 42 operates to maintain constant pressure within the reactor 32. While it is appreciated that a variable control valve is operative herein to more finely control reactor pressure, a pressure relief check valve is preferably provided at least as a safety backup to prevent the development of dangerous pressure buildup within the reactor 32.

During startup, feedstock is combusted within the catalytic burner 50 in order to heat the reactor 32 to an operating temperature. Additionally, additional feedstock is catalytically burned to compensate for the additional heat load of sudden increases in hydrogen demand placed on the purified hydrogen of output 39.

In the situation where the fuel stock combustion creates a noxious or undesirable waste gas, the waste gas stream 56 is optionally directed into a bubbler or catalytic in order to create a more benign waste gas stream. This is especially true of an inventive apparatus cracking ammonia and combusting the same to create NOₓ.

An advantage of the present invention is that electricity need only be used for powering of sensors and a control computer during steady state and optionally igniter heating in the course of apparatus startup.

Combusted feedstock is preferably passed through the boiler 30 as a high-temperature exchange medium to preheat feedstock prior to entry into the reactor 32. This serves to lower the temperature of waste gas stream 56 and limit the needed energy input to preheat feedstock within the boiler 30.

Two different types of burners are illustratively operative herein including: catalysts and a Bunsen burner with the tube removed. An alcohol or gas burner or resistively heated electric similar to your soldering igniter provides start-up heat using the catalytic burner for burning the off-gas, and also serves as a start-up igniter. An automotive catalytic converter attached to the reactor to provide good heat transfer and anchor the combustion. A flame anchoring the catalytic combustion is preferred, however, the use of a direct flame tends to limit the ability of control temperature. Alternatively, an automotive-type oxygen sensor is operative to get an input to control airflow to the burner as well. The use of fuzzy logic control within the control computer is preferred to improve stability over a broad range of operation, blending optimal control settings designed for start-up, standard operation, and turn down. It is appreciated that the feedstock slipstream to fuel a feedstock is taken either before or after the boiler. With the cost of the control valve and the convenience of taking a slipstream from between the boiler and reactor often being determinative. Patent application and publications mentioned in the specification are indicative of the levels of those skilled in the art to which the invention pertains. These patents and publications are incorporated herein by reference to the same extent as if each individual application or publication was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

What is claimed therefore is:

1. A hydrogen generation apparatus comprising:
a boiler;
a pump delivering a feedstock into said boiler;
a reactor for producing hydrogen from said feedstock;
a burner in thermal communication with said reactor, said burner receiving a catalytically combustible mixture of feedstock and a combustible gas, said feedstock being metered to said burner by a first control valve;
a waste gas outlet in full communication with said burner;
a reactor pressure sensor monitoring a reactor pressure within said reactor;
a second stage delivering a purified product gas to a product outlet and a rafinate to a rafinate outlet;
a combustion gas inlet delivering said combustible gas to said burner; and
a computer controller receiving data from said first pressure sensor and controlling said first control valve.

2. The apparatus of claim 1 wherein said purified product gas is hydrogen.

3. The apparatus of claim 1 wherein said purified product gas is carbon dioxide.

4. The apparatus of claim 1 wherein said rafinate outlet is in fluid communication with said burner.

5. The apparatus of claim 1 wherein said feedstock is an aqueous organic feedstock and said secondary stage is a water gas step membrane reactor.

6. The apparatus of claim 5 wherein said aqueous organic feedstock is selected from the group consisting of: aqueous mixtures of -alcohols, -ketones, -alkanes, -alkenes, -alkynes, -aldehydes and aliphatics.

7. The apparatus of claim 1 wherein said feedstock is ammonia and said secondary stage is a flat plate heat exchanger operating as a purifier.

8. The apparatus of claim 1 wherein said reactor comprises a flat plate heat exchanger having a lower channel passing reacting feedstock therethrough and an upper channel passing heated gases therethrough in a direction non-concurrent with flow in the lower channel.

9. The apparatus of claim 5 wherein said water gas step membrane reactor is a flat plate heat exchanger having reactant channels containing catalyst media therein and channels containing said purified gas product and having a purified product permeable gas membrane therebetween.

10. The apparatus of claim 9 wherein the membrane is a metal alloy.

11. The apparatus of claim 9 wherein the membrane is a polymer.

12. The apparatus of claim 1 further comprising a heat exchanger transferring heat between said purified product gas and said combustible gas.

13. The apparatus of claim 1 further comprising a second pressure sensor monitoring a product gas pressure in fluid communication with said product outlet.

14. The apparatus of claim 1 further comprising a second control valve metering said combustible gas to said burner, said second control valve responding to signal generated by said computer controller.

15. The apparatus of claim 1 further comprising an oxygen sensor monitoring oxygen content within said waste gas outlet and communicating the oxygen content to said computer controller.

16. A process for forming hydrogen from a feedstock comprising the steps of:
preheating a feedstock;
providing said feedstock to an exothermic reaction reactor;
allowing sufficient resonance time for said feedstock in said reactor to undergo an endothermic reaction to yield hydrogen and an endothermic reaction product;
transferring said hydrogen and said endothermic product to a secondary stage water gas step membrane reactor operating at a lower temperature than said reactor; and
collecting from secondary stage a purified hydrogen flow and a rafinate gas stream.

17. The process of claim 16 wherein said feedstock is preheated within a pump supplied boiler.

18. The process of claim 17 further comprising the step of metering said feedstock to a burner in thermal communication with said reactor so as to maintain said reactor at a temperature promoting the endothermic reaction.

19. The process of claim 18 further comprising the step of monitoring reactor temperature and communicating reactor temperature to a computer controller.

20. The process of claim 19 further comprising the step of monitoring reactor pressure and communicating reactor pressure to said computer controller.

21. The process of claim 16 further comprising the step of combusting said rafinate gas flow in said burner to yield a waste gas stream.

22. The process of claim 21 further comprising the step of heat exchanging between said waste gas stream and said feedstock so as to preheat said feedstock prior to said reactor.

23. The process of claim 16 further comprising the step of providing a combustible gas flow to said burner.

24. The process of claim 22 further comprising the step of providing feedstock to said burner so as to heat said reactor.

25. The process of claim 23 wherein said combustible gas flow is provided stoichiometrically burn said rafinate.
